(19) United States
(12) Patent Application Publication
(10) Pub. No.: US 2022/0012229 A1
(43) Pub. Date: Jan. 13, 2022

(54) CONFIGURABLE FRAMEWORK FOR GENERATING AND VALIDATING MULTI-CHANNEL ELECTRONIC DATA REPORTS

(71) Applicant: BANK OF AMERICA CORPORATION, Charlotte, NC (US)

(72) Inventors: Deepali Dadhich, Westlake Village, CA (US); ChellaPrabhu Andrew Mariadoss, Irvine, CA (US); Richa Sachdeva, Gurugram (IN)

(73) Assignee: BANK OF AMERICA CORPORATION, Charlotte, NC (US)

(21) Appl. No.: 16/922,482

(22) Filed: Jul. 7, 2020

(51) Int. Cl. G06F 16/23; G06F 3/0484

(52) U.S. Cl. CPC G06F 16/2365; G06F 3/04847

(57) ABSTRACT

Embodiments of the present invention provide a system for generating and validating multi-channel electronic data reports. The system is typically configured for generating a configurable framework, creating a package of the configurable framework, allowing a resource entity system of an entity to download the configurable framework, identifying initiation of download of the configurable framework, causing user interface to prompt input of one or more configurable parameters associated with an application present in the resource entity system, receiving the one or more configurable parameters, and integrating the configurable framework with the application to: generate one or more electronic data reports associated with the application, transmit the one or more electronic data reports to one or more end users, and track delivery of the one or more electronic data reports to the one or more end users based on the one or more configurable parameters.

### FIELD

The present invention relates to a configurable framework that is capable of integrating with any application of an entity to generate data reports associated with multiple applications.

### BACKGROUND

Typically, every application within an entity may need associates that manually generate data reports. However, such manual processing is prone to errors and ultimately results in audit issues that decrease the efficiency of applications. Thus, there is a need for a system that efficiently generates data reports associated with multiple applications, transmit data reports to the end users, and validates the delivery of the data reports.

### SUMMARY

The following presents a simplified summary of one or more embodiments of the present invention, in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

Embodiments of the present invention address the above needs and/or achieve other advantages by providing apparatuses (e.g., a system, computer program product and/or other devices) and methods for generating and validating multi-channel electronic data reports. The present invention generates a configurable framework, creates a package of the configurable framework, allows a resource entity system of an entity to download the configurable framework, identifies initiation of download of the configurable framework, causes the user interface to input one or more configurable parameters associated with an application present in the resource entity system, receives the one or more configurable parameters, and integrates the configurable framework with the application to generate one or more electronic data reports associated with the application, transmit the one or more electronic data reports to one or more end users, and track delivery of the one or more electronic data reports to the one or more end users based on the one or more configurable parameters.

In some embodiments, generating the one or more electronic data reports associated with the applications comprises receiving a trigger from the application, identifying one or more exceptions based on the one or more configurable parameters, determining a template associated with the trigger from one or more templates, aggregates data required by the template, and generates the one or more electronic data reports using the template and the aggregated data.

In some embodiments, determining the template associated with the trigger from the one or more templates is based on one or more rules.

In some embodiments, the one or more configurable parameters comprise a first flag for the one or more exceptions and a second flag for tracking the delivery of the one or more electronic data reports to the one or more end users.

In some embodiments, the configurable framework is configured to determine that the second flag for tracking the delivery of the one or more electronic data reports is positive and track the delivery of the one or more electronic data reports based on determining that the second flag is positive.

In some embodiments, the configurable framework is configured to determine that the delivery of the one or more electronic data reports is successful based on tracking the delivery of the one or more electronic data reports and archive delivery receipt associated with the delivery of the one or more electronic data reports.

In some embodiments, the configurable framework is configured to determine that the delivery of the one or more electronic data reports is not successful based on tracking the delivery of the one or more electronic data reports and notify one or more users of the application.

In some embodiments, the trigger is associated with end of process flow or a step of the process flow of the application.

In some embodiments, the present invention integrates the configurable framework with any existing applications of the entity.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, where:

FIG. 1 illustrates a block diagram illustrating a system environment for generating and validating multi-channel electronic data reports, in accordance with embodiments of the present invention.

FIG. 2 is a flowchart illustrating a process flow for allowing the configurable framework to be integrated with an application in the resource entity system of FIG. 1, in accordance with embodiments of the present invention.

FIG. 3 is a flowchart illustrating a process flow for generating and validating multi-channel electronic data reports associated with the application, in accordance with embodiments of the present invention.

### DETAILED DESCRIPTION OF EMBODIMENTS OF THE INVENTION

Embodiments of the invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident; however, that such embodiment(s) may be practiced without these specific details. Like numbers refer to like elements throughout.

Typically, each application may need to send out data reports to end users, where the reports are associated with processes or steps implemented by each application. To generate and send out data reports associated with multiple applications to multiple end users, conventional systems rely on manual generation of data reports. Such a process may be labor intensive and may be prone to human errors which is not desirable for audit purposes. Moreover, each user generating the data reports may not maintain the same format or follow the same procedure and in some instances may not generate the data reports using using a generic procedure, which makes tracking of the electronic document difficult which will in turn result in discrepancies. As such, there exists a need for a system in place to generate, transmit, and track delivery of data reports of one or more applications associated with the entity. However, if a system supporting such process were to be developed for each application individually, it may not be efficient and each such system would consume a lot of memory of resource entity systems. Therefore, the system of the present invention provides a configurable framework that can be easily integrated with any application within the entity just by changing one or more configurable parameters. The configurable framework of the present invention is generated using an automation platform. An example of supporting creation of such a framework is the Pega® Platform, which is provided by Pegasystems Inc. of Boston, Mass. It provides for an adaptive, cloud-architected software that empowers people to rapidly deploy, and easily extend and change application to meet strategic business needs, providing capabilities in content and resource management and business process management (BPM). The current invention leverages capabilities of the Pega® Platform to generate a framework that generate data reports associated with applications of the entity.

The current invention provides a configurable framework for generating data reports associated with applications of the entity. The framework may be reused by multiple applications within an entity, without having a user to develop a code for each of the applications separately. The present invention generates data reports associated with multiple applications within an entity without having to maintain thousands of templates. The present invention also enables users (or an entity) to track the delivery of the data reports. This configuration eliminates the need to (i) perform a different process for each application within an entity and (ii) allocate a resource (e.g., system) specifically for each application within the entity to perform the corresponding process.

In accordance with embodiments of the invention, the terms “resource entity” or “entity” may include any organization that uses, develops, and/or controls application software to perform one or more organizational activities. In an exemplary embodiment, the resource entity may be an organization that processes financial transactions including, but not limited to, banks, credit unions, savings and loan associations, card associations, settlement associations, investment companies, stock brokerages, resource management firms, insurance companies and the like. In another exemplary embodiment, the resource entity may be a non-financial institution. Furthermore, embodiments of the present invention use the term “end user” or “customer.” It will be appreciated by someone with ordinary skill in the art that the user may be a customer of the entity or a potential customer of the entity or an employee of the financial institution. Embodiments of the present invention use the term “associate” or “user.” In some embodiments, the end user may be an associate. It will be appreciated by someone with ordinary skill in the art that the associate may be an employee of the entity.

Many of the example embodiments and implementations described herein contemplate interactions engaged in by a user with a computing device and/or one or more communication devices and/or secondary communication devices. Furthermore, as used herein, the term “user computing device” or “mobile device” may refer to mobile phones, computing devices, tablet computers, wearable devices, smart devices and/or any portable electronic device capable of receiving and/or storing data therein.

A “user interface” is any device or software that allows a user to input information, such as commands or data, into a device, or that allows the device to output information to the user. For example, the user interface include a graphical user interface (GUI) or an interface to input computer-executable instructions that direct a processing device to carry out specific functions. The user interface typically employs certain input and output devices to input data received from a user, second user or output data to a user. These input and output devices may include a display, mouse, keyboard, button, touchpad, touch screen, microphone, speaker, LED, light, joystick, switch, buzzer, bell, and/or other user input/output device for communicating with one or more users.

A “system environment”, as used herein, may refer to any information technology platform of an enterprise (e.g., a national or multi-national corporation) and may include a multitude of servers, machines, mainframes, personal computers, network devices, front and back end systems, database system and/or the like.

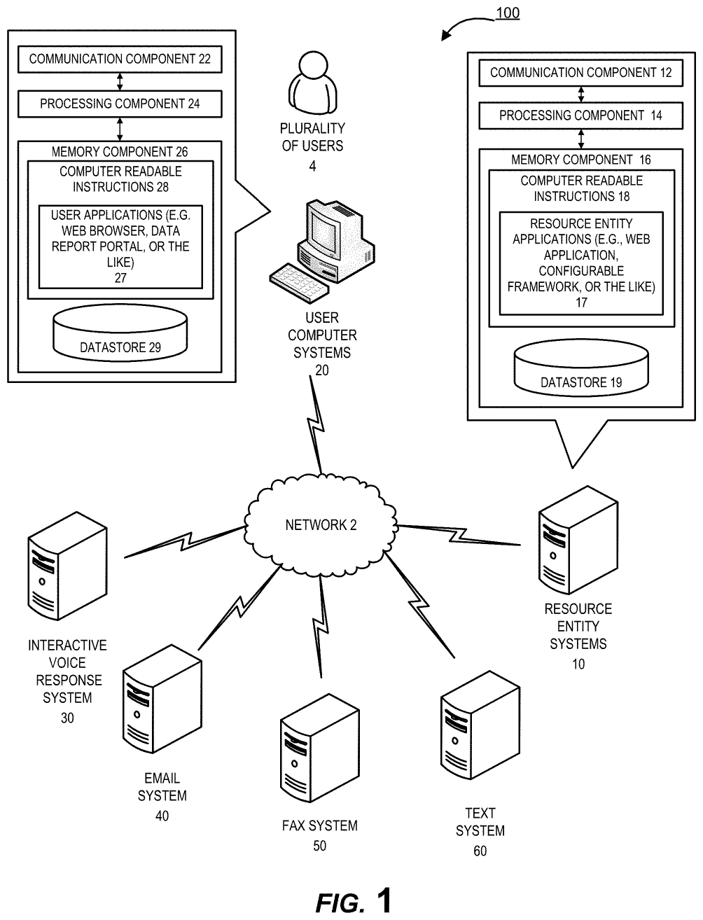

FIG. 1 illustrates a system environment 100 for generating and validating multi-channel electronic data reports, in accordance with embodiments of the invention. As illustrated in FIG. 1, one or more resource entity systems 10 are operatively coupled, via a network 2, to user computer systems 20, an interactive voice response system 30, an email system 40, a fax system 50, a text system 60, and/or one or more other systems (not illustrated). The interactive voice response system 30, the email system 40, the fax system 50, and the text system 60 are channels that allow delivery of generated data reports to one or more end users (e.g., customers or associates of the entity). In some embodiments, the system environment 100 may comprise any other systems that allow delivery of generated data reports to one or more end users. In this way, the user 4 (e.g., one or more associates, employees, agents, contractors, sub-contractors, third-party representatives, or the like), through a user application 27 (e.g., web browser, data report portal, or the like), may access resource entity applications 17 (e.g., web application, configurable framework, customer record maintenance application, transaction processing application, or the like). The resource entity applications 17 may be any application developed, utilized, or controlled by the resource entity to perform one or more organizational activities. In some embodiments, the resource entity system 10 is the system of the present invention that provides the configurable framework. Specifically, the configurable framework provided by the present invention is capable of integrating with any of the other resource entity applications 17. The configurable framework provided by the present invention as explained generates, transmits, and track delivery of the one or more data reports. In some embodiments, the system of the present invention may be an independent system that provides the configurable framework to the resource entity system 10. In such embodiments, the system of the present invention may comprise one or more processing devices operatively coupled to the one or more memory devices and configured to execute computer readable code stored in the one or more memory devices.

In some embodiments, the interactive voice response system 30, the email system 40, the fax system 50, the text system 60 may be a part of the resource entity systems 10. In some embodiments, the interactive voice response system 30, the email system 40, the fax system 50, the text system 60 may be independent systems as shown in FIG. 1. In such embodiments, the resource entity systems 10 maintain or control the interactive voice response system 30, the email system 40, the fax system 50, and the text system 60. The interactive voice response system 30, the email system 40, the fax system 50, the text system 60 may comprise one or more processing devices operatively coupled to the one or more memory devices and configured to execute computer readable code stored in the one or more memory devices.

The network 2 may be a global area network (GAN), such as the Internet, a wide area network (WAN), a local area network (LAN), or any other type of network or combination of networks. The network 2 may provide for wireline, wireless, or a combination of wireline and wireless communication between systems, services, components, and/or devices on the network 2.

As illustrated in FIG. 1, the resource entity systems 10 generally comprise one or more communication components 12, one or more processing components 14, and one or more memory components 16. The one or more processing components 14 are operatively coupled to the one or more communication components 12 and the one or more memory components 16. As used herein, the term “processing component” generally includes circuitry used for implementing the communication and/or logic functions of a particular system. For example, a processing component 14 may include a digital signal processor component, a microprocessor component, and various analog-to-digital converters, digital-to-analog converters, and other support circuits and/or combinations of the foregoing. Control and signal processing functions of the system are allocated between these processing components according to their respective capabilities. The one or more processing components 14 may include functionality to operate one or more software programs based on computer-readable instructions 18 thereof, which may be stored in the one or more memory components 16.

The one or more processing components 14 use the one or more communication components 12 to communicate with the network 2 and other components on the network 2, such as, but not limited to, the components of the user computer systems 20, the interactive voice response system 30, the email system 40, the fax system 50, the text system 60 and/or other systems. As such, the one or more communication components 12 generally comprise a wireless transceiver, modem, server, electrical connection, electrical circuit, or other component for communicating with other components on the network 2. The one or more communication components 12 may further include an interface that accepts one or more network interface cards, ports for connection of network components, Universal Serial Bus (USB) connectors and the like.

As further illustrated in FIG. 1, the resource entity systems 10 comprise computer-readable instructions 18 stored in the memory component 16, which in one embodiment includes the computer-readable instructions 18 of the resource entity application 17 (e.g., web application, configurable framework, customer record maintenance application, transaction processing application, or the like). In some embodiments, the one or more memory components 16 include one or more data stores 19 for storing data related to the resource entity systems 10, including, but not limited to, data created, accessed, and/or used by the resource entity applications 17. The independent interactive voice response system 30, the email system 40, the fax system 50, the text system 60 may include one or more memory components, wherein the one or more memory components may include instructions associated with the system of the present invention.

As illustrated in FIG. 1, plurality of users 4 may access the resource entity application 17, or other applications, through a user computer system 20. The user computer system 20 may be a desktop, mobile device (e.g., laptop, smartphone device, PDA, tablet, or other mobile device), or any other type of computer that generally comprises one or more communication components 22, one or more processing components 24, and one or more memory components 26. The plurality of users may be any employees of the resource entity system. For example, the plurality of users may be application program developers, business analysts, and/or the like. In addition, the system environment 100 may also include user computer systems of one or more end users (e.g., customers of the entity, or internal employees of the entity), wherein the one or more end users access the application software deployed by the resource entity system 10 and/or the system of the present invention on the user computer systems.

The one or more processing components 24 are operatively coupled to the one or more communication components 22 and the one or more memory components 26. The one or more processing components 24 use the one or more communication components 22 to communicate with the network 2 and other components on the network 2, such as, but not limited to, the other user computer systems, the interactive voice response system 30, the email system 40, the fax system 50, the text system 60, and/or other systems. As such, the one or more communication components 22 generally comprise a wireless transceiver, modem, server, electrical connection, or other component for communicating with other components on the network 2. The one or more communication components 22 may further include an interface that accepts one or more network interface cards, ports for connection of network components, Universal Serial Bus (USB) connectors and the like. Moreover, the one or more communication components 22 may include a keypad, keyboard, touch-screen, touchpad, microphone, mouse, joystick, other pointer component, button, soft key, and/or other input/output component(s) for communicating with a user of the plurality of users 4. In one embodiment of the present invention, the configurable framework in resource entity system 10 may provide a data report portal in the user computer systems 20 to allow the plurality of users 4 to submit requests associated with generation of data reports or review the delivery of the data reports.

As illustrated in FIG. 1, the user computer systems 20 may have computer-readable instructions 28 stored in the one or more memory components 26, which in one embodiment includes the computer-readable instructions 28 for user applications 27, such as data report portal, a web browser or other apps that allow the user to take various actions, including allowing the user to access applications located on other systems, or the like. In some embodiments, the user utilizes the user applications 27, through the user computer systems 20, to access the resource entity applications 17 to access information associated with data reports generated by the system of the present invention.

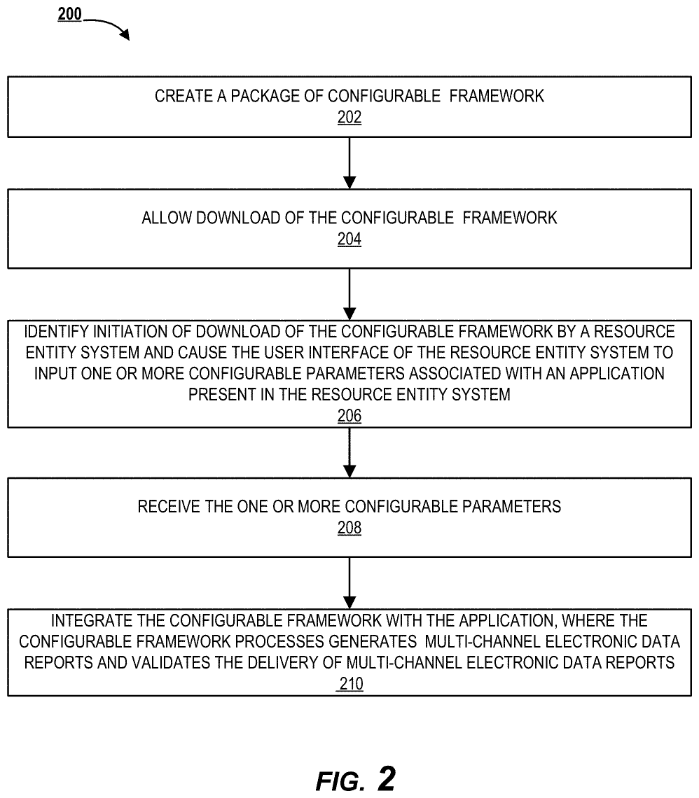

Referring now to FIG. 2, a general process flow 200 is provided for allowing the configurable framework to be integrated with an application in the resource entity system 10 of FIG. 1. Referring to block 202 through 210 of FIG. 2, as shown in block 202, the system creates a package of configurable framework, where the configurable framework is exclusively designed to generate and transmit data reports associated with one or more applications. The configurable framework comprises one or more executable program codes that are configured to generate and transmit data reports associated with the one or more applications.

As shown in block 204, the system allows download of the configurable framework. As shown in block 206, the identifies initiation of download of the configurable framework by a resource entity system and causes the user interface of the resource entity system to input one or more configurable parameters associated with an application present in the resource entity system.

As shown in block 208, the system receives the one or more configurable parameters. The one or more configurable parameters are associated with generation and transmission of data reports. The one or more configurable parameters may comprise first flag for one or more exceptions and a second flag for tracking the delivery of the electronic data reports. In some embodiments, the one or more configurable parameters are received from the resource entity system. In some embodiments the one or more configurable parameters are presented by a user 4 (e.g., an associate, application owner, or the like) via the user computing system 20. In some embodiments, the resource entity system automatically inputs the one or more configurable parameters. In some other embodiments, a user operating the resource entity system inputs the one or more configurable parameters.

As shown in block 210, the system integrates the configurable framework with the application, where the reusable framework processes generates multi-channel electronic data reports and validates the delivery of multi-channel electronic data reports. The system may integrate the configurable framework with the application by importing the one or more codes present in the package of the configurable framework into the executable codes of the application.

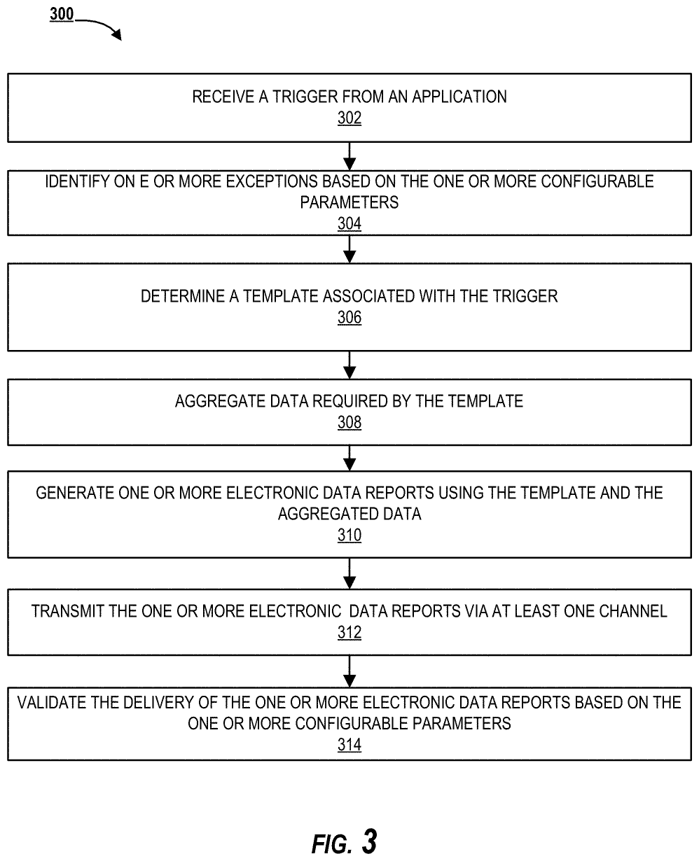

Referring now to FIG. 3, a general process flow 300 is provided generating and validating multi-channel electronic data reports associated with the application. Referring to block 302 through 314 of FIG. 3, as shown in block 302, the configurable framework receives a trigger from the application that the configurable framework is integrated into. In some embodiments, the trigger may be associated with end of a process flow associated with the application. For example, the trigger may be completion of transfer of funds. In another example, the trigger may be completion of data transfer. In some embodiments, the trigger may be associated with end of a step in the process flow. The triggers may be defined by the resource entity system 10 and/or a user 4 (e.g., an associate, application owner, an end user, or the like) in the one or more codes of the application.

As shown in block 304, the configurable framework identifies one or more exceptions based on the one or more configurable parameters. The or more exceptions may be specified in the one or more configurable parameters. A first flag may define whether one or more exceptions exist for the application. In some embodiments, while specifying the one or more configurable parameters, the user 4 or the resource entity system 10 may specify the one or more exceptions. In the case where the one or more exceptions exist, the system extracts the one or more exceptions and implements the one or more exceptions. In an example, the system may have a trigger that specifies generation and delivery of data reports upon completion of each step in the process flow of a transaction processing application. However, the one or more exceptions associated with the transaction processing application may comprise skipping generation of the data reports after certain steps of the process flow associated with the transaction processing application.

As shown in block 306, the configurable framework determines a template associated with the trigger. There may be one or more templates stored in a data repository of the resource entity systems 10, where the one or more templates are consolidated and optimized templates. For example, instead of maintaining hundreds of templates for very small variations of context, the configurable framework may crawl into the hundreds of templates and may perform consolidation of templates. In some cases, the configurable framework may automatically perform consolidation via an artificial intelligence engine. In some cases, the configurable framework may perform consolidation based on inputs from the user 4 (e.g., application owner or application analyst). In some embodiments, the configurable framework may determine the template based on the type of trigger. For example, if the trigger is associated with completion of a step of the process flow, the configurable framework automatically extracts the template that is associated with reporting of the completion of the step of the process flow associated with the application.

As shown in block 308, the configurable framework aggregates data required by the template. For example, if the template requires mailing address, first name, last name, and one or more attributes pertaining to the trigger, the configurable framework gathers the required data from one or more resource entity systems or resource entity applications. In some embodiments, the system may also gather data associated with the process flow and/or step of the process flow that caused the trigger. For example, if manipulation of a file associated with an application caused the trigger, the configurable framework gathers data associated with the type of manipulation and changes to the file to include in the data report that is being generated.

As shown in block 310, the configurable framework generates one or more electronic data reports using the template and the aggregated data. In some embodiments, the one or more electronic data reports generated by the configurable framework are bulk data reports. Completion of a step in the process flow of the application may require generation of bulk reports that are sent to all end users of the application. For example, change of a user interface element of a monitoring tool may require a report that needs to be sent out to all end users of the monitoring tool. In some embodiments, the one or more electronic data reports generated by the configurable framework are single data report that go to a single end user. For example, if the electronic request is an incoming request associated with a change of address of a customer, the configurable framework performs the address change and generates report about the successful address change.

As shown in block 312, the configurable framework transmits the one or more electronic data reports via at least one channel. The at least one channel may include an interactive voice response system 30, the email system 40, the fax system 50, the text system 60, or any other system capable of delivering data reports to the one or more end users. In some embodiments, the data report generated by the configurable framework may be a non-electronic data report. For example, a customer associated with the entity may not have access to any of the electronic means of receiving the data reports, thereby requiring generation of a paper data report and mailing of the generated paper data report. In such embodiments, the system may automatically establish a communication link and communicate with one or more printers (not shown) associated with the entity and cause the one or more printers to print the generated non-electronic data report. the In some embodiments, the configurable framework may automatically establish a communication link and communicate with mail generation system that processes one or more mails of the entity. For example, the system may communicate with the mail generation system and generate a shipping label associated with the paper data report.

As shown in block 314, the configurable framework validates the delivery of the one or more electronic data reports based on the one or more configurable parameters. If the second flag associated with tracking of the delivery of the one or more electronic data reports is positive, the configurable framework tracks the delivery of the one or more electronic data reports to the one or more end users. In such an embodiment, the configurable framework tracks the delivery of the one or more electronic data reports, determines that the delivery of the electronic data reports is successful, and stores delivery receipt associated with the delivery in archives of the application. In another such embodiment, the configurable framework tracks the delivery of the one or more electronic data reports, determines that the delivery of the electronic data reports is not successful, and notifies the user 4 about the unsuccessful delivery. The tracking method used by the configurable framework may be based on the type of channel being used for the delivery of the electronic data reports. For example, if the channel being used is the email system, then the configurable framework continuously monitors undeliverable reports received by the email system. If the second flag associated with the tracking of the delivery of the one or more electronic data reports is negative, the system generates and saves in a log, a record of generation of the electronic data report.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein. In some embodiments, memory may include volatile memory, such as volatile random access memory (RAM) having a cache area for the temporary storage of information. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory or the like) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A system for generating and validating multi-channel electronic data reports, the system comprising:
one or more memory devices having computer readable code stored thereon;
one or more processing devices operatively coupled to the one or more memory devices, wherein the one or more processing devices are configured to execute the computer readable code to:
generate a configurable framework;
create a package of the configurable framework;
allow a resource entity system of an entity to download the configurable framework;
identify initiation of download of the configurable framework;
cause user interface to prompt input of one or more configurable parameters associated with an application present in the resource entity system;
receive the one or more configurable parameters; and
integrate the configurable framework with the application to:
generate one or more electronic data reports associated with the application;
transmit the one or more electronic data reports to one or more end users; and
track delivery of the one or more electronic data reports to the one or more end users based on the one or more configurable parameters.

2. The system of claim 1, wherein generating the one or more electronic data reports associated with the application comprises:
receive a trigger from the application;
identify one or more exceptions based on the one or more configurable parameters;
determine a template associated with the trigger from one or more templates;
aggregate data required by the template; and
generate the one or more electronic data reports using the template and the aggregated data.

3. The system of claim 2, wherein determining the template associated with the trigger from the one or more templates is based on one or more rules.

4. The system of claim 2, wherein the one or more configurable parameters comprise:
a first flag for the one or more exceptions; and
a second flag for tracking the delivery of the one or more electronic data reports to the one or more end users.

5. The system of claim 4, wherein the configurable framework is configured to:
determine that the second flag for tracking the delivery of the one or more electronic data reports is positive; and
track the delivery of the one or more electronic data reports based on determining that the second flag is positive.

5. The system of claim 4, wherein the configurable framework is configured to:
determine that the delivery of the one or more electronic data reports is successful based on tracking the delivery of the one or more electronic data reports; and
archive delivery receipt associated with the delivery of the one or more electronic data reports.

6. The system of claim 4, wherein the configurable framework is configured to:
determine that the delivery of the one or more electronic data reports is not successful based on tracking the delivery of the one or more electronic data reports; and
notify one or more users of the application.

7. The system of claim 1, wherein the trigger is associated with at least one of end of process flow and a step of the process flow of the application.

8. The system of claim 1, wherein the one or more processing devices are configured to execute the computer readable code to integrate the configurable framework with any existing applications of the entity.

9. A computer program product for generating and validating multi-channel electronic data reports, the computer program product comprising at least one non-transitory computer-readable medium having computer-readable program code portions embodied therein, the computer-readable program code portions comprises one or more executable portions for:
generating a configurable framework;
creating a package of the configurable framework;
allowing a resource entity system of an entity to download the configurable framework;
identifying initiation of download of the configurable framework;
causing user interface to prompt input of one or more configurable parameters associated with an application present in the resource entity system;
receiving the one or more configurable parameters; and
integrating the configurable framework with the application to:
generate one or more electronic data reports associated with the application;
transmit the one or more electronic data reports to one or more end users; and
track delivery of the one or more electronic data reports to the one or more end users based on the one or more configurable parameters.

10. The computer program product of claim 9, wherein generating the one or more electronic data reports associated with the application comprises:
receive a trigger from the application;
identify one or more exceptions based on the one or more configurable parameters;
determine a template associated with the trigger from one or more templates;
aggregate data required by the template; and
generate the one or more electronic data reports using the template and the aggregated data.

11. The computer program product of claim 10, wherein determining the template associated with the trigger from the one or more templates is based on one or more rules.

12. The computer program product of claim 10, wherein the one or more configurable parameters comprise:
a first flag for the one or more exceptions; and
a second flag for tracking the delivery of the one or more electronic data reports to the one or more end users.

13. The computer program product of claim 9, wherein the one or more processing devices are configured to execute the computer readable code to integrate the configurable framework with any existing applications of the entity.

14. A computer implemented method for generating and validating multi-channel electronic data reports, the method comprises:
generating a configurable framework;
creating a package of the configurable framework;
allowing a resource entity system of an entity to download the configurable framework;
identifying initiation of download of the configurable framework;
causing user interface to prompt input of one or more configurable parameters associated with an application present in the resource entity system;
receiving the one or more configurable parameters; and
integrating the configurable framework with the application to:
generate one or more electronic data reports associated with the application;
transmit the one or more electronic data reports to one or more end users; and
track delivery of the one or more electronic data reports to the one or more end users based on the one or more configurable parameters.

15. The computer implemented method of claim 14, wherein generating the one or more electronic data reports associated with the application comprises:
receive a trigger from the application;
identify one or more exceptions based on the one or more configurable parameters;
determine a template associated with the trigger from one or more templates;
aggregate data required by the template; and
generate the one or more electronic data reports using the template and the aggregated data.

16. The computer implemented method of claim 15, wherein determining the template associated with the trigger from the one or more templates is based on one or more rules.

17. The computer implemented method of claim 15, wherein the one or more configurable parameters comprise:
a first flag for the one or more exceptions; and
a second flag for tracking the delivery of the one or more electronic data reports to the one or more end users.

18. The computer implemented method of claim 17, wherein the configurable framework is configured to:
determine that the second flag for tracking the delivery of the one or more electronic data reports is positive; and
track the delivery of the one or more electronic data reports based on determining that the second flag is positive.

19. The computer implemented method of claim 14, wherein the trigger is associated with end of process flow or a step of the process flow of the application.

20. The computer implemented method of claim 14, wherein the method further comprises integrating the configurable framework with any existing applications of the entity.
